(19) United States
(12) Patent Application Publication
(10) Pub. No.: US 2013/0221204 A1
(43) Pub. Date: Aug. 29, 2013

(54) SENSOR ARRANGEMENT

(71) Applicant: Leuze electronic GmbH + Co. KG, (US)

(72) Inventors: Bernhard Mueller, Herrenberg (DE); Armin Mueck, Pliezhausen (DE); Arnold Schoenleitner, Purkersdorf (AT); Robert Schedlberger, Bad Zell (AT)

(73) Assignee: Leuze electronic GmbH + Co. KG, Owen/Teck (DE)

(21) Appl. No.: 13/774,284

(22) Filed: Feb. 22, 2013

(30) Foreign Application Priority Data
Feb. 23, 2012 (DE) 102012101431.0

(51) Int. Cl. G01V 8/20

(52) U.S. Cl. CPC G01V 8/20
USPC 250/208.2

(57) ABSTRACT

A sensor arrangement comprises an arrangement of light curtains, and a trigger generator which cyclically generates trigger signals. Each trigger signal is transmitted to the light curtains, wherein a measuring operation is started following a delay time in each light curtain as a result of the trigger signal that is received.

### CROSS-REFERENCE TO RELATED APPLICATION

This application claims the priority of German Patent Application DE 10 2012 101431.0, filed on Feb. 23, 2012, the subject matter of which is incorporated herein by reference.

### TECHNICAL FIELD

Embodiments of the present invention relate to a sensor arrangement. The sensor arrangement may generally comprise an arrangement of multiple light curtains.

### BACKGROUND

Individual light curtains respectively function to detect objects within a monitored region and may comprise a transmitting unit with an arrangement of transmitters for emitting light rays and a receiving unit with an arrangement of receivers for receiving light rays. The transmitting unit and the receiving unit may be positioned on opposite edges of the monitored region, so that with a clear monitored region, the light rays from a transmitter impinge on the opposite-arranged, associated receiver, wherein this transmitter/receiver pair forms a beam axis of the light curtain. The individual beam axes of the light curtain may define the dimensions of the monitored region and are activated individually during each cycle.

An amplitude evaluation of the receiving signals takes place in an evaluation unit of the light curtain with the aid of one or several threshold values in order to generate an object-detection signal in the form of a binary switching signal. Within a single measuring cycle, for which all transmitter/receiver pairs are activated one after another, it is checked whether the light rays of at least one beam axis are interrupted. If that is the case, an object message is sent out by the evaluation unit as switching signal state. If none of the beam axes are interrupted, the switching signal state indicates a clear monitored region.

Combining several light curtains into a cascade makes possible a detection of an object in a larger region. As a result, an object can be detected in a region that essentially corresponds to the sum of the individual regions that are monitored by the light curtains of the cascade. Cascades of light curtains may furthermore be used in such a way that the individual light curtains of the cascade do not optically influence each other.

To form such a cascade, each light curtain must be provided with two connectors, wherein one connector forms a cascading output and the other connector forms a cascading input. A line is conducted from the cascading output of a light curtain to the cascading input of the adjacent light curtain in order to form a cascade. The light curtains of the cascade are activated individually one after another in the manner of a daisy chain mechanism, wherein each light curtain receives from the preceding light curtain an enable command to realize a measuring operation. In the process, a light curtain passes on the enable command to the next light curtain once a measuring operation is completed. The individual measuring operations respectively comprise a specific number of measuring cycles during which all transmitter/receiver pairs of the light curtain are activated cyclically, one after another.

Since the measuring operations of the individual light curtains are executed individually, one after another, it results in an undesirably long time period for completing the measuring operations with all light curtains of the cascade. The complete run time is furthermore not a fixed variable, but depends on the number of transmitter/receiver pairs for the individual light curtains since the measuring cycles and thus also the time intervals for all measuring operations depend on the number of transmitter/receiver pairs of the individual light curtains. A further disadvantage is that the measuring times for the individual light curtains in the cascade are not known.

A further disadvantage is that a light curtain must have two connectors which are specifically provided for integrating it into the cascade, namely a cascading output and a cascading input, which results in undesirable additional structural expenditure for the light curtains.

### SUMMARY

It is therefore an object of embodiments of the present invention to provide a sensor arrangement comprising multiple light curtains which has a higher functionality along with low structural expenditure.

This object is solved with embodiments of the present invention. Various embodiments and modifications of the present invention are described herein.

The sensor arrangement according to an embodiment of the present invention comprises an arrangement of light curtains as well as a trigger generator which cyclically generates trigger signals. Each trigger signal is transmitted to the light curtains, wherein following a predetermined delay time a measuring operation is started in each light curtain as a result of the received trigger signal.

The method of detecting an object according to an embodiment of the present invention comprises arranging a plurality of light curtains, cyclically generating a trigger signal with a trigger generator, supplying the trigger signal to the plurality of light curtains, receiving the trigger signal by each of the plurality of light curtains, and starting a measuring operation following a specified delay time in each light curtain in response to the receiving the trigger signal

According to an embodiment of the present invention, the times can be selected freely during which the measuring operations are executed with the aid of the individual light curtains. In particular, the sequence of the measuring operations is not dependent on the sequence of the light curtains within the sensor arrangement and can thus be flexibly adapted to the respective applications.

According to an embodiment of the present invention, the measuring operations of different light curtains can also take place with a time overlap or even simultaneously. Depending on the application, measuring operations are executed with a time overlap or simultaneous with light curtains which are arranged in such a way that they cannot influence each other optically, thus easily preventing incorrect detections caused by such optical influencing.

As a result of the parallel running of the measuring operations, the run times for activating the individual measuring operations and thus the reaction times for the sensor arrangement, according to an embodiment of the present invention, can be reduced considerably while the clocking rates for generating the object detection signals are increased. The faster detection of objects, which is achieved in this way, also increases the detection certainty of the sensor arrangement.

According to an embodiment of the present invention, the trigger generator periodically generates respectively one trigger signal in the form of a trigger pulse during a cycle time. Each measuring operation extends over a specific measuring interval, wherein the measuring intervals for all light curtains fall within one cycle time.

A periodic operation of the sensor arrangement is ensured with such an embodiment of the present invention, wherein the cycle time represents the time period in which the individual light curtains respectively execute one measuring operation.

The trigger signal in the form of a trigger pulse may supply a defined reference point for the individual delay times and thus for the start of the measuring operations in the individual light curtains.

According to an embodiment of the present invention, the individual trigger signals are supplied in parallel to the light curtains.

The trigger signal or, in particular, the trigger pulse may therefore be present simultaneously at all light curtains and consequently defines a reference point for the start of a cycle time. According to an embodiment of the present invention, the measuring operations maybe precisely coordinated with respect to time, but are executed within the specified cycle time.

The relative times specified for the measuring operations within the cycle time are determined by the individual delay times and are stored in the respective light curtains as parameters that can be adjusted. By specifying the delay times in a parameter setting step, the time behavior of the sensor arrangement can be easily predetermined.

According to an embodiment of the present invention, the light curtains and the trigger generator are connected via a system with lines, wherein the light curtains are provided with only one connector for connecting these lines.

Since only one connector must be provided and not, as is the case with the other light curtain cascades, a separate cascade output and a cascade input, the structural expenditure is considerably reduced for incorporating the light curtains into the sensor arrangement.

According to an embodiment of the present invention, the trigger generator is integrated into an external unit that may be independent of the light curtains. The connectors for the light curtains are respectively embodied as inputs.

The external unit can be a control unit, for example, according to an embodiment of the present invention, which can function to operate a machine or a system in dependence on the detection of objects realized with the sensor arrangement. The control unit can furthermore realize a central evaluation of the object detections realized with the individual light curtains. Depending on the application, separate object detection signals can respectively be generated in the individual light curtains which are then evaluated jointly in the control unit. Alternatively, the measuring results from the individual light curtains can also be evaluated directly, so that an object detection signal for the complete sensor arrangement is generated only in the control unit.

According to an embodiment of the present invention, the trigger generator is integrated into a light curtain for which the connector can optionally be switched as input or output. The connectors of the remaining light curtains are respectively embodied as inputs.

According to an embodiment of the present invention, joint object detection signal or a separate object detection signal for each light curtain is generated.

### BRIEF DESCRIPTION OF THE DRAWINGS

These and other features and advantages of the invention will be further understood from the following detailed description of the embodiments with reference to the accompanying drawings in which:

FIG. 1 shows a first exemplary embodiment of the sensor arrangement according to the invention;

FIG. 2 shows a time graph for the operation of the sensor arrangement according to FIG. 1;

FIG. 3 shows a second exemplary embodiment of the sensor arrangement according to the invention;

FIG. 4 shows time graphs for the operation of the sensor arrangement according to FIG. 3.

### DETAILED DESCRIPTION

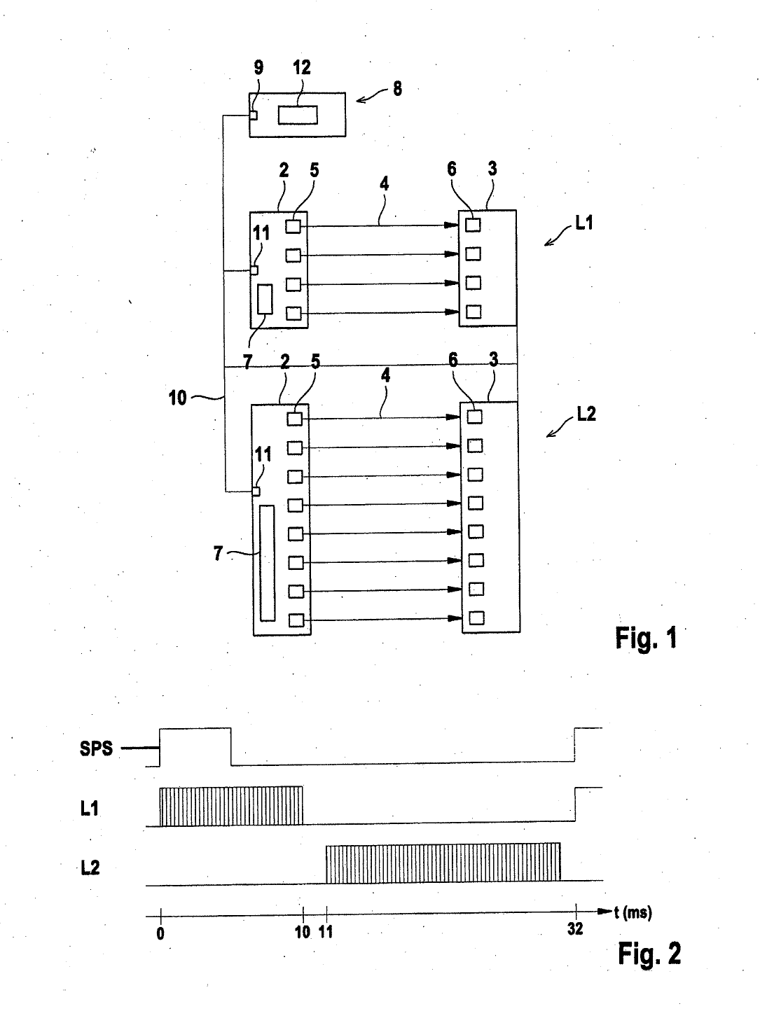

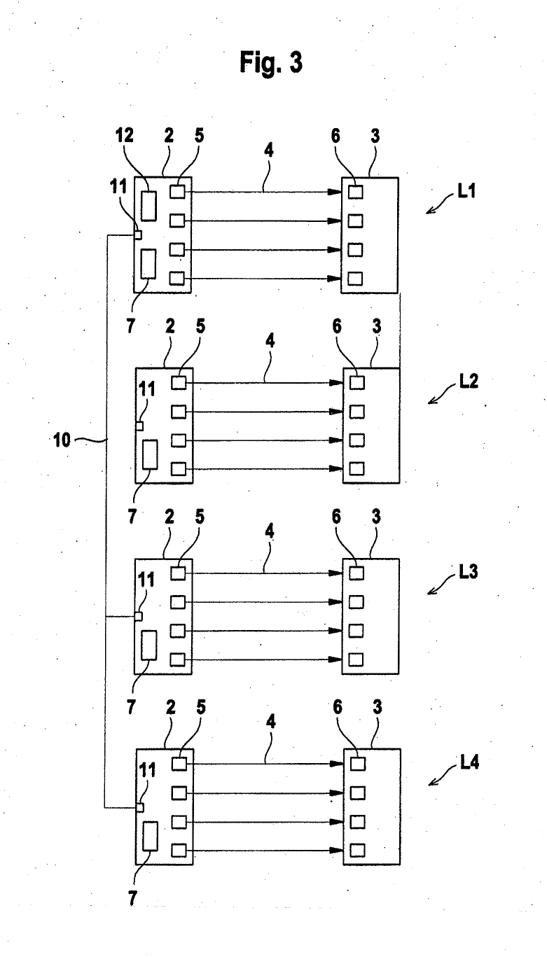

FIGS. 1 and 3 show two embodiments of a sensor arrangement 1, comprising several light curtains L1, L2 and/or L1-L4.

Each light curtain L1-L4 comprises a transmitting unit 2 with a first casing and a receiving unit 3 with a second casing. The transmitting unit 2 and the receiving unit 3 are positioned at opposite edges of a monitored region, within which objects can be detected with the light curtain L1-L4.

A linear arrangement of transmitters 5 for emitting light rays 4 is arranged inside the casing for the transmitting unit 2. The casing for the receiving unit 3 contains a linear arrangement of a number of receivers 6 that receive the light rays 4, wherein the number of receivers corresponds to the number of transmitters.

An opposite-arranged receiver 6 is assigned to each transmitter 5, such that with a clear monitoring region the light rays 4 emitted by the transmitter 5 impinge on the associated receiver 6. As a result, the transmitters 5 and the receivers 6 form transmitter/receiver pairs, wherein each pair forms a so-called beam axis for the light curtain L1-L4.

The transmitter/receiver pairs of each light curtain L1-L4 are activated individually and successively during a cycle with the aid of an evaluation and control unit 7 to which the transmitters 5 and the receivers 6 are connected. The activation of the transmitter/receiver pairs may occur cyclically, within fixedly predetermined measuring cycles, wherein each transmitter/receiver pair is activated once during each measuring cycle.

The object may furthermore be recorded in the evaluation and control unit 7 with the aid of comparing the receiving signals to threshold values from all the receivers 6 in the evaluation unit. As a result of this threshold value evaluation, it is determined whether or not the light rays 4 of a beam axis have been interrupted by an object intervention. An object detection signal may be generated based on the beam interruption, for example, in the form of a switching signal which indicates whether or not an object is present.

Two light curtains L1, L2 are provided for the sensor arrangement 1 according to FIG. 1. The light curtain L1 comprises four beam axes while the light curtain L2 comprises eight beam axes. The light curtains L1, L2 are connected to the control unit 8 which in the present embodiment is embodied as SPS [memory program control] unit. A line 10 is conducted from a connector 9 of the control unit 8 to the connectors 11 of the light curtains L1, 12, wherein these connectors are embodied as inputs in the present embodiment. The light curtains L1, L2 are connected parallel via the line 10 to the control unit 8.

A trigger generator 12 for generating trigger signals in the form of trigger pulses may be provided in the control unit 8. To control the time behavior of the light curtains L1, L2 with the control 8, the trigger pulses are output via the lines 10 to both light curtains L1, L2.

This time behavior is illustrated in FIG. 2. SPS denotes the periodic sequence of trigger pulses which are generated in the trigger generator 12 and are output in parallel to the light curtains L1, L2. Respectively at the start of a cycle time, the trigger generator 12 generates a trigger pulse, wherein the cycle time for the present embodiment is 32 ms. The rising edge of the trigger pulse forms a triggering point for the start of a measuring operation with a light curtain L1, L2. The start of a measuring operation within a cycle time is computed in each light curtain L1, L2 starting with the point in time for the rising edge of the trigger pulse received by the control unit 8. For this, a delay time may be stored as an adjustable parameter in each light curtain L1, L2. In addition, the starting point for the measuring operation of the light curtain L1, L2 is stored in each light curtain L1, L2. The measuring times may be whole number multiples of the measuring cycles for the respective light curtains L1, L2. In the present embodiment, the delay time stored for the light curtain L1 is 0 ms while the delay time for the light curtain L2 is 11 ms. The measuring time for the light curtain L1 is 10 ms while the measuring time for the light curtain L2 is 20 ms since the light curtain L1 comprises twice the number of beam axes as the light curtain L2. The time behavior shown in FIG. 2 results from these parameters. With the rising edge of the trigger pulse, the measuring operation of the light curtain L1 is started immediately since its delay time is 0 ms. This measuring operation lasts 10 ms. Since the delay time 11 ms is stored for the light curtain L2, the measuring operation of the second light curtain L2 only starts 1 ms after deactivation of the measuring operation of the light curtain L1, so that the measuring operations of the two light curtains L1, L2 do not influence each other. The measuring operation of the second light curtain L2 ends 1 ms before the end of the cycle time. Following this first cycle time, the second cycle time may be started with the next trigger pulse. The time behavior of the light curtains L1, L2 during the further cycle times may be identical to that of the first cycle time.

In general, each light curtain L1, L2 may independently generate object detection signals during a measuring operation. According to an embodiment of the present invention, it is also possible to read the measuring results from the individual light curtains L1, L2 into the control unit 8 and to evaluate the results therein for generating an object detection signal for the complete sensor arrangement 1.

FIG. 3 shows a sensor arrangement 1 with four light curtains L1-L4 which are provided with connectors 11, analogous to the embodiments shown in FIG. 1, wherein a line 10 that is connected to the connectors 11 connects the light curtains L1-L4 in the form of a parallel connection.

In contrast to the embodiment according to FIG. 1, no control unit 8 is provided for the sensor arrangement 1 shown in FIG. 3. The trigger generator 12, according to an embodiment of the present invention, may be integrated into the first light curtain L1 for which the connector 9 can be operated as input and output. As a result, the trigger pulses generated in the trigger signal can thus be transmitted via the connector 9 to all additional light curtains L2-L4, so that the total time behavior of the sensor arrangement 1 can be controlled with the trigger pulses.

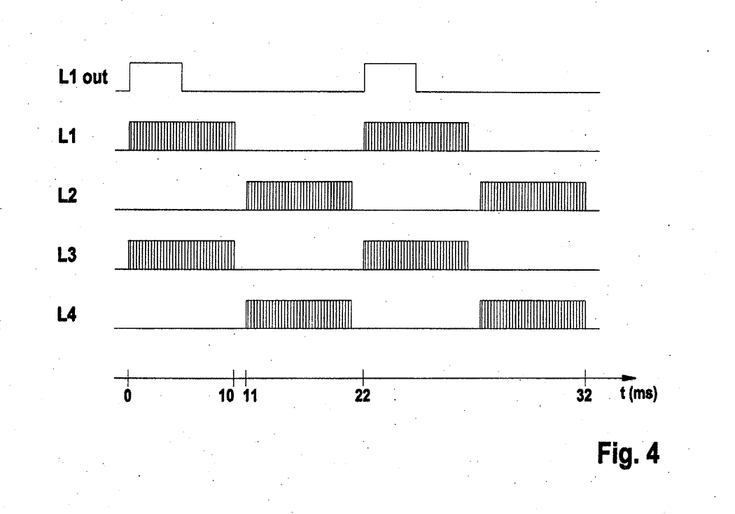

In the present embodiment, the sensor arrangement 1 comprises four identical light curtains L1-L4 with respectively four beam axes. Within one cycle time or cycle period, meaning the time interval between two trigger pulses, each light curtain L1-L4 is activated to realize a measuring operation. The times for the measuring operations are the same for all light curtains L1-L4 and amount to 10 ms. The cycle time is 22 ms. FIG. 4 shows the time behavior of the sensor arrangement 1 according to FIG. 3 for two successively following cycle times.

The start of the individual measuring operations is again computed in that for each light curtain L1-L4, a delay time is added at the point in time for the rising edge of a trigger pulse, wherein this delay time may be stored as parameter value in the respective light curtain L1-L4, in the evaluation and control unit 7. In the present embodiment, identical delay times of 0 ms are stored for the light curtains L1, L3 and identical delay times of 11 ms are stored for the light curtains L2, L4. As a result, the light curtains L1, L3 have identical measuring times, meaning they are operated in parallel. The light curtains L2, L4 are also operated in parallel, but with a time offset relative to the light curtains L1, L3.

This passage of time is matched to the spatial arrangement of the light curtains L1-L4 within the sensor arrangement 1 according to FIG. 3. Since the light curtains L1, L3 are not located directly adjacent to each other, they also cannot influence each other optically. That is to say, it is not possible for the light rays 4 belonging to the light curtain L1 to radiate into the light curtain L3 or vice versa. For that reason, the light curtains L1, L3 may be operated in parallel. The same is true for the light curtains L2, L4 which are also not positioned adjacent to each other.

Analogous to the embodiment shown in FIG. 1, a separate object detection signal can also be generated for each light curtain L1-L4 with the sensor arrangement 1 shown in FIG. 3, or a joint object detection signal can be generated for the sensor arrangement 1.

It will be understood that the above description of the present invention is susceptible to various modifications, changes and adaptations, and the same are intended to be comprehended within the meaning and range of equivalents of the appended claims.

We claim:

1. A sensor arrangement comprising:
an arrangement of light curtains;
a trigger generator configured to cyclically generate a trigger signal that is supplied to each light curtain; and
a storage associated with each light curtain to store a specified delay time so that in response to the trigger signal a measuring operation is started in each light curtain following the specified delay time.

2. The sensor arrangement of claim 1, wherein the trigger generator is configured to generate a trigger signal that comprises a trigger pulse during each cycle time.

3. The sensor arrangement of claim 2, wherein each measuring operation lasts for a specific time period, wherein the measuring times for all light curtains fall within a single cycle time.

4. The sensor arrangement of claim 3, wherein the storage associated with each light curtain is included in the respective light curtain.

5. The sensor arrangement of claim 4, wherein the delay times are adjustable parameters.

6. The sensor arrangement of claim 1, wherein the light curtains are arranged electrically to receive each trigger signal in parallel.

7. The sensor arrangement of claim 1, further comprising a line system having lines connecting each light curtain and the trigger generator, wherein each light curtain comprises only a single connector for connecting the lines to each light curtain.

8. The sensor arrangement according to claim 7, further comprising an external unit, wherein the trigger generator is integrated into the external unit, wherein the external unit is independent of the light curtains, wherein the connector of each light curtain is an input.

9. The sensor arrangement of claim 7, wherein the trigger generator is integrated into one of the light curtains, wherein the connector for the one of the light curtains is an input and an output, wherein the connectors for the other light curtains are inputs.

10. The sensor arrangement of claims 1, wherein a joint object detection signal is generated for the sensor arrangement, or a separate object detection signal is generated for each light curtain.

11. A method of detecting an object comprising:
arranging a plurality of light curtains,
cyclically generating a trigger signal with a trigger generator,
supplying the trigger signal to the plurality of light curtains,
receiving the trigger signal by each of the plurality of light curtains, and
starting a measuring operation following a specified delay time in each of the plurality of light curtains in response to receiving the trigger signal.

12. The method of claim 11, wherein the cyclically generating a trigger signal comprises generating the trigger signal in the form of a trigger pulse during each cycle time.

13. The method of claim 12, wherein each measuring operation lasts for a specific time period, wherein the measuring times for all of the plurality of light curtains fall within a single cycle time.

14. The method of claim 13, further comprising storing the delay times in each of the plurality of light curtains.

15. The method of claim 14, wherein the delay times comprise adjustable parameters.

16. The method of claim 11, wherein supplying each trigger signal comprises supplying each trigger signal in parallel to the plurality of light curtains.

17. The method of claim 11, further comprising connecting the plurality of light curtains and the trigger generator, wherein each of the plurality of light curtains comprises only a single connector for connecting the lines to each of the plurality of light curtains.

18. The method of claim 17, further comprising integrating the trigger generator into an external unit that is independent of the plurality of light curtains, wherein the connectors of the plurality of light curtains are inputs.

19. The method of claim 17, further comprising integrating the trigger generator into one of the plurality of light curtains for which the connector switches between input or output, wherein the connectors for the other of the plurality of light curtains are inputs.

20. The method of claims 11, further comprising generating a joint detection signal for the plurality of light curtains, or generating a separate object detection signal for each of the plurality of light curtains.
